(19) United States
(12) Patent Application Publication
(10) Pub. No.: US 2023/0213611 A1
(43) Pub. Date: Jul. 6, 2023

(54) METHODS, SYSTEMS, AND MEDIA FOR LOCATING VIBRATION SIGNAL SOURCES

(71) Applicant: SHENZHEN SHOKZ CO., LTD., Shenzhen (CN)

(72) Inventors: Le XIAO, Shenzhen (CN); Yongshuai YUAN, Shenzhen (CN); Yujia HUANG, Shenzhen (CN); Fengyun LIAO, Shenzhen (CN); Xin QI, Shenzhen (CN)

(73) Assignee: SHENZHEN SHOKZ CO., LTD., Shenzhen (CN)

(21) Appl. No.: 18/054,525

(22) Filed: Nov. 10, 2022

Related U.S. Application Data
(63) Continuation of application No. PCT/CN2021/143727, filed on Dec. 31, 2021.

(51) Int. Cl. G01S 5/22

(52) U.S. Cl. CPC G01S 5/22

(57) ABSTRACT

Some embodiments of the present disclosure provide a method for locating a vibration signal source. The method may include obtaining sensing signals of at least two vibration sensing devices located at different locations, each of the sensing signals being generated by one of the at least two vibration sensing devices by sensing a vibration signal generated by a vibration, which is from the same vibration signal source; determining, based on the sensing signals, a time difference between time points when the at least two vibration sensing devices located at different locations receive the vibration signal; and determining, based on the time difference, a location of the vibration signal source.

### CROSS-REFERENCE TO RELATED APPLICATIONS

This application is a continuation of International Patent Application No. PCT/CN2021/143727, filed on Dec. 31, 2021, the entire contents of which are incorporated herein by reference.

### TECHNICAL FIELD

The present disclosure generally relates to the field of locating a signal source, and in particular, relates to methods, systems, and media for locating a vibration signal source.

### BACKGROUND

The analysis and research on a vibration signal source not only includes the identification of signal features of the vibration signal source, but also includes locating the vibration signal source. How to accurately and quickly determine the location of the vibration signal source has great significance to the analysis and research on the vibration signal source.

The present disclosure provides methods for locating the vibration signal source, which can quickly and accurately determine the location of the vibration signal source.

### SUMMARY

Some embodiments of the present disclosure provide a method for locating a vibration signal source. The method may include obtaining sensing signals of at least two vibration sensing devices located at different locations, each of the sensing signals being generated by one of the at least two vibration sensing devices by sensing a vibration signal, which is generated by a vibration from the same vibration signal source; determining, based on the sensing signals, a time difference between time points when the at least two vibration sensing devices located at different locations receive the vibration signal; and determining, based on the time difference, a location of the vibration signal source.

In some embodiments, the determining, based on the sensing signals, a time difference between time points when the at least two vibration sensing devices located at different locations receive the vibration signal may include identifying signal features of the sensing signals; identifying target signal features corresponding to the vibration signal source in the signal features; and determining a time difference between the target signal features.

In some embodiments, the identifying signal features of the sensing signals may include determining, based on spectra of the sensing signals, the signal features of the sensing signals.

In some embodiments, the identifying target signal features corresponding to the vibration signal source in the signal features may include identifying the target signal features in the sensing signals using a target signal feature identification model. The target signal feature identification model may be a machine learning model.

In some embodiments, the method may further include obtaining locations of the vibration signal source at a plurality of time points; and determining, based on the locations of the vibration signal source at the plurality of time points, a motion trajectory of the vibration signal source.

In some embodiments, the method may further include determining, based on the motion trajectory of the vibration signal source, a next location of the vibration signal source.

In some embodiments, the determining, based on the motion trajectory of the vibration signal source, a next location of the vibration signal source may include determining, based on the motion trajectory of the vibration signal, a motion velocity and a motion acceleration of the vibration signal source at a current location; and determining, based on the motion velocity and the motion acceleration of the vibration signal source at the current location and the current location of the vibration signal source, the next location of the vibration signal source.

In some embodiments, the at least two vibration sensing devices located at different locations may be respectively connected to a vibration receiving region through a solid medium, and generate the sensing signals in response to the vibration generated by the same vibration signal source in the vibration receiving region.

In some embodiments, the at least two vibration sensing devices located at different locations may be respectively fixedly connected to the solid medium through at least one of a bonding connection, an inlaying connection, a welding connection, a riveting connection, or a screw connection.

In some embodiments, the at least two vibration sensing devices located at different locations may be detachably connected to the solid medium.

In some embodiments, the determining, based on the time difference, a location of the vibration signal source may include obtaining a vibration transmission velocity of the solid medium; and determining the location of the vibration signal source based on the vibration transmission velocity of the solid medium and the time difference between the target signal features.

In some embodiments, the obtaining a vibration transmission velocity of the solid medium may include obtaining relevant information of the solid medium; and determining, based on the relevant information of the solid medium, the vibration transmission velocity corresponding to the solid medium.

In some embodiments, the relevant information of the solid medium may at least include a size of the solid medium, a type of a material of the solid medium, a vibration transmission velocity of the material of the solid medium, and a shape of the solid medium.

In some embodiments, the obtaining a vibration transmission velocity of the solid medium may include obtaining a test distance between a test vibration signal source and a test vibration sensing device; obtaining a test time when the test vibration sensing device receives the test vibration signal; and determining, based on the test time and the test distance, the vibration transmission velocity of the solid medium.

In some embodiments, at least three vibration sensing devices of the at least two vibration sensing devices may be respectively disposed at different locations of a contact control device. The contact control device may include a contact control region, and the at least three vibration sensing devices may generate the sensing signals in response to the vibration of the same vibration signal source in the contact control region.

In some embodiments, at least three vibration sensing devices of the at least two vibration sensing devices may be disposed at different locations of a racket. The method may further include determining whether the location of the vibration signal source is within a recommendation hitting region; and in response to a determination result that the location of the vibration signal source is not within the recommendation hitting region, prompting that a hitting location is improper.

In some embodiments, the at least two vibration sensing devices may be disposed at different locations of an object to be detected. The target signal features may include abnormal signal features corresponding to a defective pixel of the object to be detected.

In some embodiments, the object to be detected may include a railroad track.

In some embodiments, the identifying target signal features corresponding to the vibration signal source in the signal features may further include, for each of the signal features of the sensing signals, determining whether the signal feature of the sensing signals satisfies a preset feature condition; and in response to a determination result that the signal feature satisfies the preset feature condition, determining the signal feature as one of the abnormal signal features.

In some embodiments, the determining, based on the time difference, a location of the vibration signal source may further include determining a location of the defective pixel based on a time difference between the abnormal signal features.

Some embodiments of the present disclosure provide a system for locating a vibration signal source. The system may include at least one storage device configured to store computer instructions; and at least one processor in communication with the at least one storage device. When executing the computer instructions, the at least one processor may be configured to direct the system to perform operations including obtaining sensing signals of at least two vibration sensing devices located at different locations, each of the sensing signals being generated by one of the at least two vibration sensing devices by sensing a vibration signal, which is generated by a vibration from the same vibration signal source; determining, based on the sensing signals, a time difference between time points when the at least two vibration sensing devices located at different locations receive the vibration signal; and determining, based on the time difference, a location of the vibration signal source.

In some embodiments, the determining, based on the sensing signals, a time difference between time points when the at least two vibration sensing devices located at different locations receive the vibration signal may include identifying signal features of the sensing signals; identifying target signal features corresponding to the vibration signal source in the signal features; and determining a time difference between the target signal features.

In some embodiments, the identifying signal features of the sensing signals may include determining, based on spectra of the sensing signals, the signal features of the sensing signals.

In some embodiments, the identifying target signal features corresponding to the vibration signal source in the signal features may include identifying the target signal features in the sensing signals using a target signal feature identification model. The target signal feature identification model may be a machine learning model.

In some embodiments, the method may further include obtaining locations of the vibration signal source at a plurality of time points; and determining, based on the locations of the vibration signal source at the plurality of time points, a motion trajectory of the vibration signal source.

In some embodiments, the method may further include determining, based on the motion trajectory of the vibration signal source, a next location of the vibration signal source.

In some embodiments, the determining, based on the motion trajectory of the vibration signal source, a next location of the vibration signal source may include determining, based on the motion trajectory of the vibration signal, a motion velocity and a motion acceleration of the vibration signal source at a current location; and determining, based on the motion velocity and the motion acceleration of the vibration signal source at the current location and the current location of the vibration signal source, the next location of the vibration signal source.

In some embodiments, the at least two vibration sensing devices located at different locations may be respectively connected to a vibration receiving region through a solid medium, and generate the sensing signals in response to the vibration generated by the same vibration signal source in the vibration receiving region.

In some embodiments, the at least two vibration sensing devices located at different locations may be respectively fixedly connected to the solid medium through at least one of a bonding connection, an inlaying connection, a welding connection, a riveting connection, or a screw connection.

In some embodiments, the at least two vibration sensing devices located at different locations may be detachably connected to the solid medium.

In some embodiments, the determining, based on the time difference, a location of the vibration signal source may include obtaining a vibration transmission velocity of the solid medium; and determining the location of the vibration signal source based on the vibration transmission velocity of the solid medium and the time difference between the target signal features.

In some embodiments, the obtaining a vibration transmission velocity of the solid medium may include obtaining relevant information of the solid medium; and determining, based on the relevant information of the solid medium, the vibration transmission velocity corresponding to the solid medium.

In some embodiments, the relevant information of the solid medium may at least include a size of the solid medium, a type of a material of the solid medium, a vibration transmission velocity of the material of the solid medium, and a shape of the solid medium.

In some embodiments, the obtaining a vibration transmission velocity of the solid medium may include obtaining a test distance between a test vibration signal source and a test vibration sensing device; obtaining a test time when the test vibration sensing device receives the test vibration signal; and determining, based on the test time and the test distance, the vibration transmission velocity of the solid medium.

In some embodiments, at least three vibration sensing devices of the at least two vibration sensing devices may be respectively disposed at different locations of a contact control device. The contact control device may include a contact control region, and the at least three vibration sensing devices may generate the sensing signals in response to the vibration of the same vibration signal source in the contact control region.

In some embodiments, at least three vibration sensing devices of the at least two vibration sensing devices may be disposed at different locations of a racket. The method may further include determining whether the location of the vibration signal source is within a recommendation hitting region; and in response to a determination result that the location of the vibration signal source is not within the recommendation hitting region, prompting that a hitting location is improper.

In some embodiments, the at least two vibration sensing devices may be disposed at different locations of an object to be detected. The target signal features may include abnormal signal features corresponding to a defective pixel of the object to be detected.

In some embodiments, the object to be detected may include a railroad track.

In some embodiments, the identifying target signal features corresponding to the vibration signal source in the signal features may further include, for each of the signal features of the sensing signals, determining whether the signal feature of the sensing signals satisfies a preset feature condition; and in response to a determination result that the signal feature satisfies the preset feature condition, determining the signal feature as one of the abnormal signal features.

In some embodiments, the determining, based on the time difference, a location of the vibration signal source may further include determining a location of the defective pixel based on a time difference between the abnormal signal features.

Some embodiments of the present disclosure provide a non-transitory computer readable medium. The non-transitory computer readable medium may include at least one set of computer instructions. When executed by at least one processor, the at least one set of computer instructions may direct the at least one processor to perform operations including obtaining sensing signals of at least two vibration sensing devices located at different locations, each of the sensing signals being generated by one of the at least two vibration sensing devices by sensing a vibration signal, which is generated by a vibration from the same vibration signal source; determining, based on the sensing signals, a time difference between time points when the at least two vibration sensing devices located at different locations receive the vibration signal; and determining, based on the time difference, a location of the vibration signal source.

### BRIEF DESCRIPTION OF THE DRAWINGS

The present disclosure is further illustrated in terms of exemplary embodiments. These exemplary embodiments are described in detail with reference to the drawings. These embodiments are not restrictive. In these embodiments, the same number indicates the same structure, wherein:

FIG. 1 is a schematic diagram illustrating an exemplary system for locating a vibration signal source according to some embodiments of the present disclosure;

FIG. 2 is a flowchart illustrating an exemplary process for locating a vibration signal source according to some embodiments of the present disclosure;

FIG. 3 is a block diagram illustrating an exemplary system for locating a vibration signal source according to some embodiments of the present disclosure;

FIG. 4 is a flowchart illustrating an exemplary process for determining a location of a vibration signal source according to some embodiments of the present disclosure;

FIG. 5 is a schematic diagram illustrating an exemplary contact control device disposed with vibration sensing devices according to some embodiments of the present disclosure;

FIG. 6 is a schematic diagram illustrating an exemplary racket disposed with vibration sensing devices according to some embodiments of the present disclosure;

FIG. 7 is a schematic diagram illustrating an exemplary court disposed with vibration sensing devices according to some embodiments of the present disclosure; and

FIG. 8 is a schematic diagram illustrating an exemplary railroad track disposed with vibration sensing devices according to some embodiments of the present disclosure.

### DETAILED DESCRIPTION

In order to illustrate the technical solutions related to the embodiments of the present disclosure, a brief introduction of the drawings referred to in the description of the embodiments is provided below. Obviously, the drawings described below are only some examples or embodiments of the present disclosure. Those having ordinary skills in the art, without further creative efforts, may apply the present disclosure to other similar scenarios according to these drawings. Unless stated otherwise or obvious from the context, the same reference numeral in the drawings refers to the same structure and operation.

As used in the disclosure and the appended claims, the singular forms “a,” “an,” and “the” include plural referents unless the content clearly dictates otherwise. In general, the terms “comprise,” “comprises,” and/or “comprising,” “include,” “includes,” and/or “including,” merely prompt to include steps and elements that have been clearly identified, and these steps and elements do not constitute an exclusive listing. The methods or devices may also include other steps or elements. The term “based on” is “based at least in part on.” The term “one embodiment” represents “at least one embodiment.” The term “another embodiment” represents “at least one other embodiment.” Related definitions of other terms will be given in the description below.

Some embodiments of the present disclosure provide methods and systems for locating a vibration signal source. The methods may include obtaining sensing signals generated by at least two vibration sensing devices located at different locations. The sensing signals may be generated by the at least two vibration sensing devices after obtaining a vibration signal, which is generated by a vibration from the same vibration signal source. By identifying signal features of the sensing signals, target signal features corresponding to a vibration signal source may be determined, and then a time difference between time points when the at least two vibration sensing devices located at different locations receive the vibration generated by a specific vibration behavior of the vibration signal source may be determined. Finally, a location of the vibration signal source corresponding to the target signal features may be determined based on the time difference.

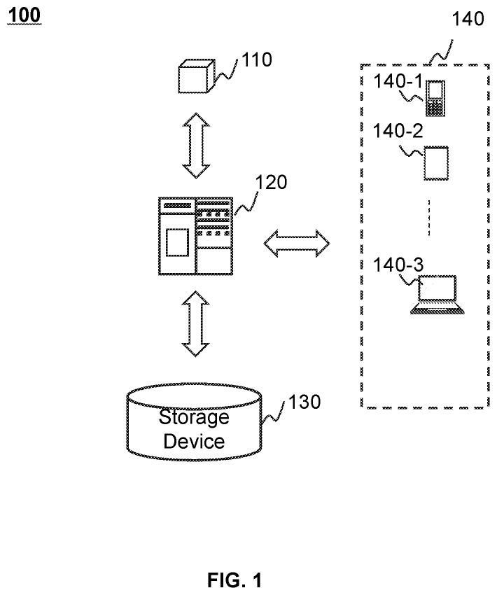

FIG. 1 is a schematic diagram illustrating an exemplary system 100 for locating a vibration signal source according to some embodiments of the present disclosure. For the convenience of illustration, the system 100 for locating the vibration signal source may be referred to as the system 100 for short. The system 100 may include a vibration sensing device 110, a processing device 120, and a storage device 130. In some embodiments, the system 100 may obtain a sensing signal generated by the vibration sensing device 110 according to a received external vibration signal. In some embodiments, the system 100 may identify target signal features corresponding to the vibration signal source, and determine a location of the vibration signal source corresponding to the external vibration signal based on a time difference between the target signal features. Each component in the system 100 may be connected to each other in a wired or wireless way.

The vibration sensing device 110 may generate a sensing signal (e.g., an electrical signal) based on a collected external mechanical vibration signal (also referred to as a vibration signal). In some embodiments, the external mechanical vibration signal may be derived from a specific vibration behavior generated by a specific signal vibration source. The signal vibration source may refer to a subject or a specific portion of the subject that performs a specific vibration behavior (e.g., a contact between teeth of an upper gum and teeth of a lower gum of the user, a contact between a finger of the user and a contact control region, a contact between a ball and a racket, a contact between a player and a court ground, etc.) to generate a vibration, thereby generating the vibration signal. For example, a vibration may be generated when a basketball in a basketball court contacts with a ground of the basketball court, thereby generating a vibration signal, and the basketball may be regarded as a vibration signal source of the vibration signal. As another example, when an athlete moves on a basketball court, feet of the athlete may contact with the ground of the basketball court, and a vibration signal may also be generated by the contact between the feet of the athlete and the ground of the basketball court. Therefore, the feet of the athlete may be regarded as a vibration signal source of the vibration signal. In some embodiments, the vibration signal generated by the specific signal vibration source may be transmitted to the vibration sensing device 110 via a medium (e.g., a solid medium), and the vibration sensing device 110 may generate a corresponding sensing signal based on the received vibration signal. For example, the vibration sensing device 110 disposed on a contact control device may collect a vibration signal generated by an operation (e.g., by knocking, scratching, etc.) located in a contact control region, and generate a corresponding sensing signal. In some embodiments, since the vibration signal is hardly affected by environmental noise (e.g., noise caused by air vibration) during transmission, the vibration signal may be accurately and effectively collected by the vibration sensing device 110.

The processing device 120 may process data and/or information obtained from the vibration sensing device 110 or other components of the system 100. For example, the processing device 120 may process sensing signals obtained from the vibration sensing device 110. In some embodiments, the processing device 120 may be a processor (e.g., a chip of the vibration sensing device 110) of the vibration sensing device 110 itself. Therefore, the vibration sensing device 110 may be used to pick up and collect the vibration signal, and process the generated sensing signal (including identifying signal features of the sensing signal). In some embodiments, the processing device 120 may be an independent server or a server group. The server group may be centralized or distributed. In some embodiments, the processing device 120 may be local or remote. For example, the processing device 120 may access information and/or data from the vibration sensing device 110 and/or the storage device 130. As another example, the processing device 120 may be directly connected to the vibration sensing device 110 and/or the storage device 130 to access information and/or data. In some embodiments, the processing device 120 may include one or more processors (e.g., single-core processor(s) or multi-core processor(s)).

The storage device 130 may store data, instructions, and/or any other information, such as the sensing signal obtained by the processing device 120, the signal features of the sensor signal identified by the processing device 120, etc. In some embodiments, the storage device 130 may store data (e.g., the vibration signal) obtained from the vibration sensing device 110 and/or the processing device 120. In some embodiments, the storage device 130 may store data and/or instructions that the processing device 120 may execute or use to perform exemplary methods described in the present disclosure.

In some embodiments, the system 100 may also include a user terminal 140. The user terminal 140 may be used to receive and/or transmit information and/or data. In some embodiments, the user terminal 140 may include a mobile device 140-1, a tablet computer 140-2, a laptop computer 140-3, or the like, or any combination thereof. In some embodiments, the user terminal 140 may communicate with and/or connect to the vibration sensing device 110, the processing device 120, and/or the storage device 130. For example, the user may input relevant information (e.g., a vibration transmission velocity of the solid medium) of the solid medium through the user terminal 140. In some embodiments, the mobile device 140-1 may include a wearable device, a smart mobile device, a virtual reality device, an augmented reality device, a smart toy, a smart speaker, or the like, or any combination thereof.

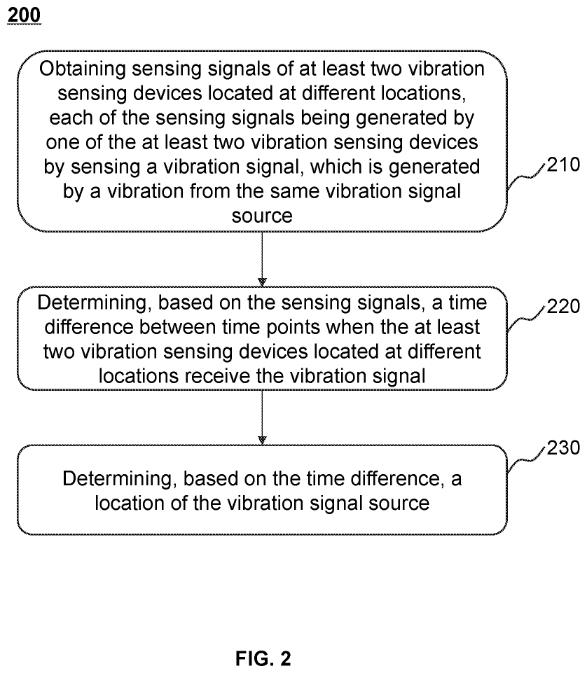

FIG. 2 is a flowchart illustrating an exemplary process 200 for locating a vibration signal source according to some embodiments of the present disclosure. In some embodiments, the process 200 for locating the vibration signal source may be executed by the system 100 (e.g., the processing device 120). For example, the process 200 for locating the vibration signal source may be stored in a storage device (e.g., the storage device 130) in the form of a program or an instruction. When the system 100 (e.g., the processing device 120) executes the program or instruction, the process 200 for locating the vibration signal source may be implemented.

In 210, the processing device 120 may obtain sensing signals of at least two vibration sensing devices located at different locations. Each of the sensing signals may be generated by one of the at least two vibration sensing devices by sensing a vibration signal, which is generated by a vibration from a same vibration signal source. In some embodiments, the operation 210 may be performed by a sensing signal obtaining module 310.

A sensing signal may refer to a signal generated by the vibration sensing device 110 after the vibration sensing device 110 receives an external vibration signal. For example, a sensing signal may be an electrical signal generated by the vibration sensing device 110 based on a received external vibration signal. In some embodiments, the external vibration signal may refer to a mechanical vibration signal (also referred to as a vibration signal).

The vibration sensing device 110 may refer to a device that can collect a mechanical vibration signal. For example, the vibration sensing device 110 may be a microphone (also referred to a bone conduction microphone) that receives a bone conduction sound signal as one of the main sound signals, an accelerometer, etc.

In some embodiments, a vibration signal may be generated when the vibration signal source performs a specific vibration behavior. The specific vibration behavior may include a body activity (e.g., chewing and swallowing, a tooth tapping, rubbing, etc.) of a user, collision or contact between objects (e.g., a contact between a ball and a racket, a contact between a ball and a court ground, a contact between a railroad track and a train), a specific operation (e.g., a knocking, scraping, etc.) performed in a specific region, etc. The vibration sensing device 110 may receive the vibration signal by connecting with the above-mentioned subject, and generate a corresponding sensing signal based on the vibration signal.

In some embodiments of the present disclosure, a count (or number) of the vibration sensing device 110 may be at least two. Therefore, when the same vibration signal source generates the vibration signal, the at least two vibration sensing devices 110 may simultaneously or successively receive the vibration signal corresponding to the vibration signal source, and generate the corresponding sensing signals based on the vibration signal.

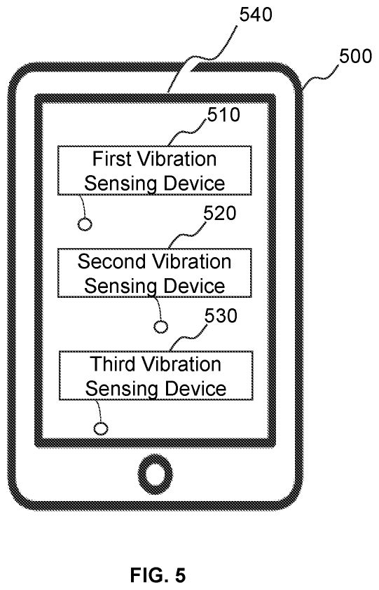

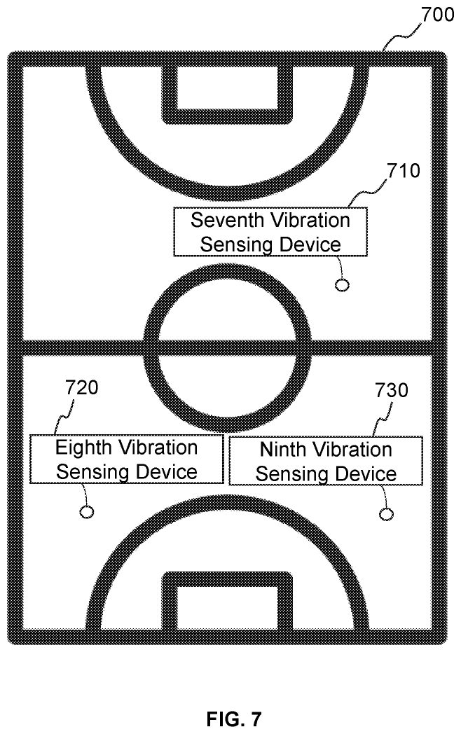

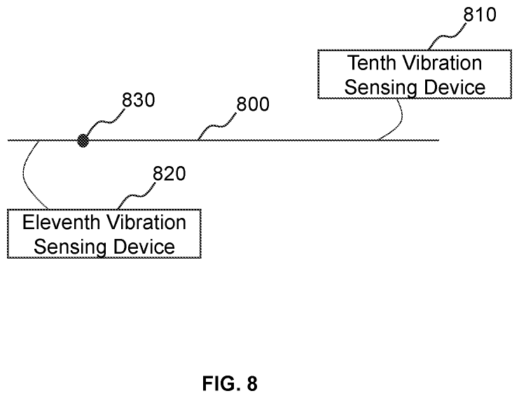

In some embodiments, the count (or number) of the vibration sensing devices 110 may be determined according to different application scenarios. For example, when the application scenario is a one-dimensional scenario (e.g., a railroad track shown in FIG. 8 may be regarded as a line segment extending along a length direction of the railroad track), the (or number) count of the vibration sensing devices 110 may be two. As another example, when the application scenario is a two-dimensional scenario (e.g., a court shown in FIG. 7 may be regarded as a two-dimensional plane), the count (or number) of the vibration sensing devices 110 may be three. More descriptions regarding the count (or number) of the vibration sensing devices 110 may be found elsewhere in the present disclosure (e.g., FIGS. 5-8 and the descriptions thereof), which may not be described herein.

In 220, the processing device 120 may determine, based on the sensing signals, a time difference between time points when the at least two vibration sensing devices located at different locations receive the vibration signal. In some embodiments, operation 220 may be performed by a time difference determination module 320.

In some embodiments, since the at least two vibration sensing devices 110 are disposed at different locations of a same object (e.g., the solid medium), and the transmission velocity of the vibration signal in the same object is substantially the same, the time points when the at least two vibration sensing devices 110 receive the vibration signal may be different. The vibration signal received by the at least two vibration sensing devices 110 disposed at different locations may have the time difference. The time difference (also referred to as a first time difference) may refer to a difference value between time points when the vibration signal generated by the vibration from the same vibration signal source is transmitted to the at least two vibration sensing devices 110. In some embodiments, the time point when the vibration signal is received by a specific vibration sensing device 110 may be determined based on a time point when the specific vibration sensing device 110 generates the sensing signal. Therefore, the time difference may be determined based on a time difference between time points when the at least two vibration sensing devices 110 generate their respective sensing signals. For example, if a time point when one vibration sensing device 110 receives a vibration signal from a vibration signal source and generates a sensing signal is T1, and a time point when another vibration sensing device 110 located at a different location receives the vibration signal from the same vibration signal source and generates another sensing signal is T2, a time difference between the time points when the two vibration sensing devices located at different locations receive the vibration signal may be T1-T2.

In some embodiments, the vibration signal received by the vibration sensing device 110 may include vibration signals other than the vibration signal (i.e., a target vibration signal) generated by the vibration signal source (i.e., a target vibration signal source). For example, when a location of a ball on a court needs to be detected, vibration signals received by a vibration sensing device 110 may include a target vibration signal generated by a contact between the ball and a court ground and other noises (e.g., a vibration signal generated by a contact between a foot of a player and the court ground). Therefore, before the time difference is determined, the processing device 120 may need to identify the target vibration signal from the vibration signals received by the vibration sensing device 110.

In some embodiments, the processing device 120 may identify signal features of the sensing signals, and then may identify target signal features corresponding to the vibration signal source among the signal features. Finally, a time difference (also referred to as a second time difference) between the target signal features may be determined. In some embodiments, the second time difference between the target signal features may indicate the first time difference between the time points when the at least two vibration sensing devices located at different locations receive the vibration signal. The second time difference between the target signal features may refer to a time difference between occurrence times of the target signal features in the sensing signals generated by the at least two vibration sensing devices. For example, if the at least two vibration sensing devices include a first vibration sensing device and a second vibration sensing device, the second time difference between the target signal features may be a time difference between a first occurrence time of a target signal feature in a sensing signal generated by the first vibration sensing device and a second occurrence time of a target signal feature in a sensing signal generated by the second vibration sensing device. As another example, if the at least two vibration sensing devices includes a first vibration sensing device, a second vibration sensing device, and a third vibration sensing device, the second time difference between the target signal features may include a time difference between the first occurrence time and the second occurrence time, a time difference between the first occurrence time and a third occurrence time of a target signal feature in a sensing signal generated by the third vibration sensing device, and a time difference between the second occurrence time and the third occurrence time.

A signal feature may refer to relevant information that reflects signal characteristics. In some embodiments, for a vibration signal, the signal features of the corresponding sensing signal may include a count of vibration peaks, a signal strength, a time interval between adjacent vibration peaks, frequency components, a signal duration, or the like, or any combination thereof.

The count of vibration peaks may refer to a count of vibration peaks whose amplitude is greater than a preset amplitude. In some embodiments, the count of vibration peaks may reflect a count feature of a vibration signal (e.g., a count of times that the user knocks a contact control region, a count of times of chewing and swallowing, a count of times that the ball contacts the ground of the court, etc.). The signal strength may refer to a strength of a signal. In some embodiments, the signal strength may reflect a strength feature of an external signal (e.g., a strength that the user knocks or scratches the contact control region). In some embodiments, the stronger the user knocks and scratches, the greater the signal strength of the generated vibration signal. The time interval between two adjacent vibration peaks may refer to a time interval between two adjacent vibration peaks in a vibration signal. In some embodiments, the time interval of two adjacent vibration peaks may reflect a density feature of a vibration signal (e.g., a time interval that the user knocks or scratches the contact control region, a time interval that the user chews and swallows, a time interval that the ball contacts the ground of the court, etc.). The frequency components of a signal may refer to frequency distribution information of the sensing signal. The frequency distribution information may include, for example, a distribution of high-frequency signals, medium-high-frequency signals, medium-frequency signals, medium-low-frequency signals, low-frequency signals, etc. In some embodiments, the high frequency, medium-high frequency, medium frequency, medium-low frequency and/or low frequency in the present disclosure may be artificially defined. For example, a high-frequency signal may be a signal with a frequency greater than 4000 Hz. A medium-high-frequency signal may be a signal with a frequency within a range of 2500 Hz to 5000 Hz. A medium-frequency signal may be a signal with a frequency within a range of 1000 Hz to 4000 Hz. A medium-high-frequency signal may be a signal with a frequency within a range of 600 Hz to 2000 Hz. A low-frequency signal may be a signal with a frequency within a range of 20 Hz to 1000 Hz. The signal duration may refer to a duration of an entire sensing signal or a duration of a single vibration peak of the sensing signal. For example, the entire sensing signal may include three vibration peaks, and the duration of the entire sensing signal may be 3 seconds.

In some embodiments, the processing device 120 may determine a signal feature spectrum of the sensing signal by performing time domain processing and/or frequency domain processing on the sensing signal, thereby determining the signal features of the sensing signal. For example, the processing device 120 may obtain (e.g., retrieve) relevant information (e.g., the count of vibration peaks, the frequency components of the signal, etc.) from a signal feature spectrum of the sensing signal, thereby determining signal features of the sensing signal.

In some other embodiments, the processing device 120 may determine, based on the sensing signal, the signal features of the sensing signal through an algorithm. Exemplary algorithms may include a wavelet packet energy feature extraction algorithm, a Mel-frequency cepstral coefficients (MFCC) parameter feature extraction algorithm, etc.

In some embodiments, when a target signal feature appears in the signal features, it may indicate that the vibration sensing device receives a target vibration signal. Therefore, the processing device 120 may determine whether the vibration sensing device 110 receives the target vibration signal by identifying whether a signal feature is the target signal feature. In some embodiments, the processing device 120 may determine whether a signal feature satisfies a preset feature condition. When the signal feature satisfies the preset feature condition, the processing device 120 may determine that the signal feature is the target signal feature corresponding to the vibration signal source. The preset feature condition may include that the count of vibration peaks is greater than a count threshold, the signal duration is greater than a duration threshold, or the like, or any combination thereof. The target signal feature corresponding to the vibration signal source may refer to a target signal feature that is the same as or similar to the signal feature of the vibration signal generated by the vibration signal source. For example, if a signal duration of the vibration signal generated by the vibration signal source is greater than 2 seconds, the processing device 120 may identify a signal feature whose signal duration is greater than 2 seconds from the signal features, and designate the identified signal feature as a target signal feature corresponding to the vibration signal source.

In some embodiments, the processing device 120 may identify one or more target signal features corresponding to the vibration signal source in the signal features based on a target signal feature identification model. The processing device 120 may input the sensing signal or the signal feature spectrum into the target signal feature identification model. An output of the target signal feature identification model may include the target signal feature(s) corresponding to the vibration signal source or the relevant information (e.g., a location, an occurrence time, etc., of the target signal feature(s) in the sensing signal) of the target signal feature(s). In some embodiments, the target signal feature identification model may be a first machine learning model. The target signal feature identification model may be a trained first machine learning model. The first machine learning model may include various models and structures, for example, a deep neural network model, a recurrent neural network model, a custom model structure, etc.

In some embodiments, when training the target signal feature identification model, signal feature spectra of a plurality of sensing signals with labels (or identifiers) may be used as training data. Parameters of the target signal feature identification model may be learned through ways such as gradient decent. In some embodiments, the target signal feature identification model may be trained in other devices or modules.

In some embodiments, after the target signal feature(s) are identified, the processing device 120 may determine occurrence times of the target signal feature(s). In some embodiments, for each of the sensing signals generated by the at least two vibration sensing devices 110 disposed at different locations, the processing device 120 may determine the occurrence time of the corresponding target signal feature in the sensing signal based on the above-mentioned operations. The processing device 120 may determine a time difference between the occurrence times of the target signal features (i.e., the second time difference between the target signal features) in different sensing signals.

In 230, the processing device 120 may determine, based on the time difference, a location of the vibration signal source. In some embodiments, the operation 230 may be performed by a location determination module 330.

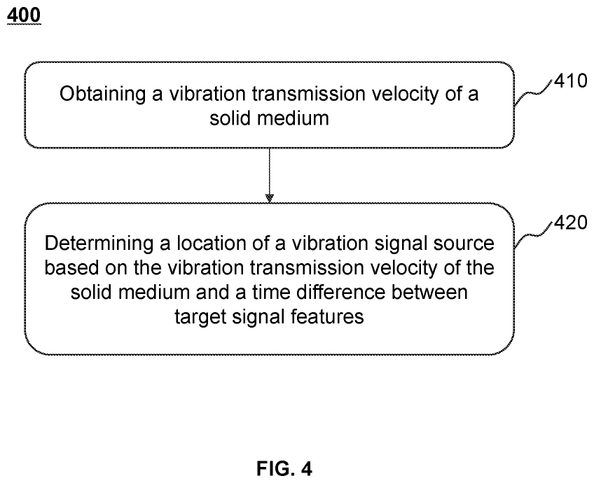

In some embodiments, for each of the at least two vibration sensing devices 110, the processing device 120 may determine a distance between the vibration signal source corresponding to the target signal features and the vibration sensing device 110 based on the second time difference between the target signal features and the transmission velocity of the vibration signal. The processing device 120 may further determine the location of the vibration signal source according to the at least two distances. In some embodiments, since the vibration signal of the present disclosure propagates in the solid medium, the transmission velocity of the vibration signal may be regarded as a vibration transmission velocity of a mechanical vibration in the solid medium. More descriptions regarding the determination of the vibration transmission velocity of the mechanical vibration in the solid medium may be found elsewhere in the present disclosure (e.g., FIG. 4 and the descriptions thereof), which may not be described herein.

In some embodiments, for a sensing signal generated by a vibration sensing device 110, the processing device 120 may determine the location of the vibration signal source corresponding to the target signal feature(s) of the sensing signal using a machine learning model based on the relevant information of the target signal feature(s) in the sensing signal. In some embodiments, the processing device 120 may determine the location of the vibration signal source based on a location determination model. The processing device 120 may input the relevant information of the target signal features (e.g., the location, the occurrence time, etc., of the target signal feature(s) in each sensing signal) into the location determination model. An output of the location determination model may include the location of the vibration signal source. In some embodiments, the location determination model may be a second machine learning model. The location determination model may be a trained machine learning model. The second machine learning model may include various models and structures, for example, a deep neural network model, a recurrent neural network model, a custom model structure, etc. In some embodiments, a training process of the location determination model may be similar to training processes of other models, which may not be described herein.

In some alternative embodiments, the processing device 120 may determine the location of the vibration signal source directly based on the signal features of the sensing signals generated by the at least two vibration sensing devices 110. For example, in the embodiments shown in FIG. 7, a court 700 may be evenly divided into several sufficiently small regions. One or more vibration sensing devices 110 may be placed in each of the several sufficiently small regions to collect a large count of vibration signals. Then, signal features of sensing signals corresponding to the vibration signals may be marked, and the location of the signal vibration source corresponding to the vibration signal collected in each of the several sufficiently small regions may be designated as a label of the vibration signal collected in each of the several sufficiently small regions. The processing device 120 may further use the labeled vibration signals as training samples to train the second machine learning model. By using the trained second machine learning model, the processing device 120 may directly determine the location of the vibration signal source based on the signal features.

In some embodiments, the vibration signal source may be in a motion state. The processing device 120 may determine a motion trajectory of the vibration signal source. For example, the vibration sensing device 110 may receive a vibration signal generated by each specific vibration behavior of a vibration signal source and generate a corresponding sensing signal. For instance, the processing device 120 may determine a location of a basketball every time the basketball contacts a court ground according to sensing signals caused by the contact, and determine a motion trajectory of the basketball based on the plurality of locations.

In some embodiments, the processing device 120 may obtain locations of the vibration signal source at a plurality of time points during the motion. The processing device 120 may determine, based on the locations of the vibration signal source at the plurality of time points, the motion trajectory of the vibration signal source. The location mentioned herein may refer to a location where the vibration signal source generates a vibration signal. For example, a basketball in a motion state may contact with a court ground at a plurality of time points, and each contact may generate a corresponding vibration signal. The motion trajectory may refer to a motion path of the vibration signal source within a specific time period. In some embodiments, the processing device 120 may determine the locations of the vibration signal source at the plurality of time points based on the operations described in the process 200. The locations of the vibration signal source at the plurality of time points may be connected in a time sequence, and a connection line may be the motion trajectory of the vibration signal source. In some embodiments, the processing device 120 may store the obtained locations of the vibration signal source at the plurality of time points and the corresponding time points in the storage device 130.

In some embodiments, the processing device 120 may determine a next location of the vibration signal source based on the motion trajectory of the vibration signal source. In some embodiments, the next location may refer to a location where the vibration signal source generates a next vibration signal. In some other embodiments, the next location may also refer to a location where the vibration signal source is located at a next moment.

In some embodiments, the processing device 120 may determine a motion velocity and a motion acceleration of the vibration signal source at a current location based on the motion trajectory of the vibration signal. In some embodiments of the present disclosure, the current location may refer to a location where the vibration signal source is located at a current moment.

In some embodiments, the processing device 120 may determine the motion velocity and the motion acceleration of the vibration signal source at the current location based on three locations of the vibration signal source in the motion trajectory. For example, the processing device 120 may select a location (denoted as location A) of the vibration signal source at a current time point and locations (denoted as location B and location C, respectively) of the vibration signal source at two consecutive time points before the current time point from the motion trajectory. Equation(s) related to the motion velocity and the motion acceleration may be established based on an elapsed time of the vibration signal source from the location B to the location A, a distance from the location B to the location A, an elapsed time of the vibration signal source from the location C to the location A, and a distance from the location C to the location A, and the motion velocity and motion acceleration of the vibration signal source at the current location may be obtained by solving the equation(s).

In some embodiments, the processing device 120 may determine the next location of the vibration signal source based on the motion velocity and the motion acceleration of the vibration signal source at the current location and the current location of the vibration signal source. It may be understood that both motion velocity and motion acceleration are vectors that have directions. Therefore, the next location of the vibration signal source may be determined by establishing the equation(s) related to the motion velocity and the motion acceleration based on the motion velocity, the motion acceleration, the current location of the vibration signal source, and a time to move to the next location.

In some embodiments, the processing device 120 may determine, based on the sensing signals, whether vibration signal sources in the contact control region of the contact control device are a same vibration signal source. In some embodiments, the processing device 120 may determine, based on the sensing signals, time differences among time points when at least three vibration sensing devices disposed at different locations on the contact control device receive the vibration signal. In some embodiments, the processing device 120 may determine the location of the same vibration signal source in the contact control region of the contact control device based on the time differences. More descriptions regarding the determination of the location of the same vibration signal source based on the time differences may be found elsewhere in the present disclosure (e.g., FIG. 5 and the descriptions thereof), which may not be described herein.

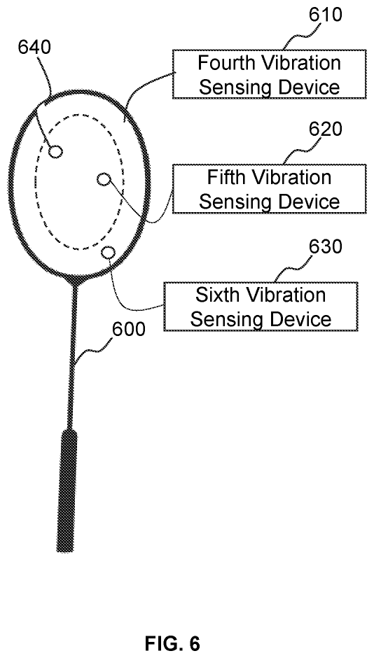

In some embodiments, the processing device 120 may determine whether the ball is in contact with the racket based on the sensing signals. In some embodiments, the processing device 120 may determine, based on the sensing signals, time differences among time points when at least three vibration sensing devices disposed at different locations on the racket receive vibration signal(s) from the contact between the ball and the racket. In some embodiments, the processing device 120 may determine, based on the time differences, whether a contact location (i.e., a hitting location) between the ball and the racket is within a recommendation hitting region. In some embodiments, in response to a determination result that the location of the vibration signal source is not within the recommendation hitting region, the processing device 120 may prompt that the hitting location is improper. More descriptions regarding the determination of whether the hitting location is located within the recommendation hitting region based on the time differences may be found elsewhere in the present disclosure (e.g., FIG. 6 and the descriptions thereof), which may not be described herein.

In some embodiments, the processing device 120 may determine whether the ball or the player is in contact with the court ground based on the sensing signals. In some embodiments, the processing device 120 may determine, based on the sensing signals, time differences among time points when at least three vibration sensing devices disposed at different locations on the court ground receive vibration signal(s) generated from the contact between the ball or the player and the court ground. In some embodiments, the processing device 120 may determine a location of the ball or player on the court ground based on the time differences. More descriptions regarding the determination of the location of the same vibration signal source based on the time differences may be found elsewhere in the present disclosure (e.g., FIG. 7 and the descriptions thereof), which may not be described herein.

In some embodiments, the processing device 120 may determine whether an object to be detected (e.g., a railroad track) includes a defective pixel based on the sensing signals. In some embodiments, the processing device 120 may determine, based on the sensing signals, a time difference between time points when at least two vibration sensing devices disposed at different locations on the object to be detected receive vibration signal(s) generated by the defective pixel. In some embodiments, the processing device 120 may determine a location of the defective pixel based on the time difference. More descriptions regarding the determination of the location of the defective pixel on the railroad track based on the time difference may be found elsewhere in the present disclosure (e.g., FIG. 8 and the descriptions thereof), which may not be described herein.

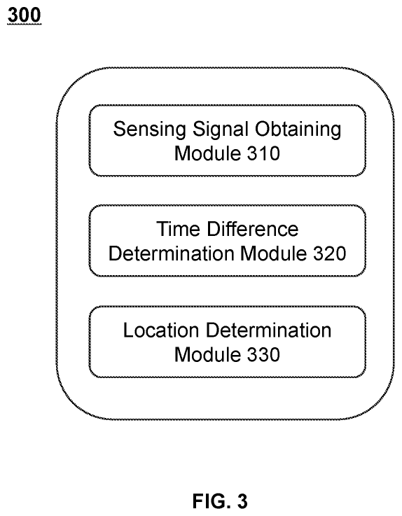

FIG. 3 is a block diagram illustrating an exemplary system 300 for locating a vibration signal source according to some embodiments of the present disclosure. As shown in FIG. 3, the system 300 for locating the vibration signal source may include a sensing signal obtaining module 310, a time difference determination module 320, and a location determination module 330. In some embodiments, the system 300 for locating a vibration signal source may be implemented by the system 100 (e.g., the processing device 120) shown in FIG. 1.

In some embodiments, the sensing signal obtaining module 310 may be configured to obtain sensing signals of at least two vibration sensing devices located at different locations. Each of the sensing signals may be generated by one of the at least two vibration sensing devices by sensing a vibration signal, which is generated by a vibration from the same vibration signal source.

In some embodiments, the time difference determination module 320 may determine, based on the sensing signals, a time difference between time points when the at least two vibration sensing devices located at different locations receive the vibration signal.

In some embodiments, the location determination module 330 may determine the location of the vibration signal source based on the time difference.

It should be understood that the system 300 and its modules shown in FIG. 3 may be implemented in various ways. For example, in some embodiments, the system 300 and its modules may be implemented in hardware, software, or a combination of software and hardware. The hardware may be implemented by a dedicated logic. The software may be stored in a storage, the system may be executed by proper instructions, for example, by a microprocessor or a dedicated design hardware. Those skilled in the art can understand that, the methods and systems described above may be implemented by the executable instructions of a computer and/or by control code in the processor. The system 300 and its modules in the present disclosure may be implemented by a hardware circuit in a programmable hardware device such as an ultra large scale integrated circuit, a gate array, etc., software executed by various processors, or a combination thereof (e.g., a firmware).

It should be noted that the above descriptions of the system 300 and its modules are merely provided for the convenience of description, and do not limit the scope of the present disclosure. It will be understood that for those skilled in the art, after understanding the principle of the system 300, it is possible to arbitrarily combine various components, or form subsystems to connect with other components without departing from this principle. For example, in some embodiments, the time difference determination module 320 and the location determination module 330 may be integrated into one module. As another example, each module may share the storage device 130, or each module may also have its own storage device 130. Those variations are still within the scope of the present disclosure.

In some embodiments, the vibration sensing device 110 may collect a vibration signal in a specific region. The specific region (also referred to as a vibration receiving region) may be a region for receiving a vibration signal. In some embodiments, the vibration sensing device 110 may obtain the vibration signal of the vibration receiving region, and generate a corresponding sensing signal.

In some embodiments, at least two vibration sensing devices 110 may be respectively connected to the vibration receiving region through a solid medium. A vibration signal received by the vibration receiving region may be transmitted to the at least two vibration sensing devices 110 through the solid medium. The at least two vibration sensing devices 110 may generate sensing signals in response to a vibration generated by the same vibration signal source in the vibration receiving region. In some embodiments, the solid medium may be a metal (e.g., stainless steel, aluminum alloy, etc.), a non-metal (e.g., wood, plastic, etc.), etc. For example, in the embodiments shown in FIG. 6, a racket net of a racket 600 may be a vibration receiving region. A fourth vibration sensing device 610, a fifth vibration sensing device 620, and a sixth vibration sensing device 630 may be disposed on the racket net of the racket 600 or a frame of the racket 600, and generate sensing signals in response to a vibration generated by the same vibration signal source (e.g., a tennis ball) in the vibration receiving region. In some embodiments, the vibration receiving region may be a specific region on the solid medium. For example, in the embodiments shown in FIG. 7, the solid medium may be a court ground. A seventh vibration sensing device 710 may be disposed on an upper half region of the court ground, and an eighth vibration sensing device 720 and a ninth vibration sensing device 730 may be disposed on a lower half region of the court ground.

In some embodiments, the at least two vibration sensing devices 110 may be fixedly connected to the solid medium in various ways. For example, the at least two vibration sensing devices 110 located at different locations may be respectively fixedly connected to the solid medium by at least one of a bonding connection, an inlaying connection, a welding connection, a riveting connection, a screw connection, or a magnetic suction connection. In some cases, the at least two vibration sensing devices 110 may have good and firm contact with the solid medium, so that vibration signal(s) may be accurately and effectively transmitted from the solid medium to the at least two vibration sensing devices 110. For example, in the embodiments shown in FIG. 6, the fourth vibration sensing device 610, the fifth vibration sensing device 620, and the sixth vibration sensing device 630 may be bonded to the racket net of the racket 600.

In some embodiments, the at least two vibration sensing devices 110 may be respectively detachable relative to the solid medium. For example, the at least two vibration sensing devices 110 may be connected to the solid medium by means of clamp connection, magnetic suction connection, buckle connection, screw connection, etc. In some cases, the vibration sensing device 110 may be detachably connected to the solid medium. In some other cases, the detachable connection between the vibration sensing device 110 and the solid medium may facilitate an installation of the vibration sensing device 110 on any solid medium, so as to detect the vibration signal generated in a specific vibration receiving region. For example, at least three vibration sensing devices 110 may be respectively mounted on a desktop (since the desktop may be regarded as a two-dimensional scenario, a count of vibration sensing devices may be at least three), to determine the location of the vibration signal source on the desktop through the at least three vibration sensing devices 110.

In some embodiments, when a vibration sensing device 110 is connected to the vibration receiving region through the solid medium, a vibration signal may be transmitted to the vibration sensing device 110 through the transmission of the solid medium. On the basis of the second time difference between the target signal features which has been determined above, a transmission velocity of the vibration signal in the solid medium (i.e., a vibration transmission velocity of the solid medium) may need to be obtained. The system 100 may determine a distance between the vibration signal source and the vibration sensing device 110 based on the second time difference between the target signal features and the transmission velocity of the vibration signal in the solid medium, thereby determining the location of the vibration signal source.

FIG. 4 is a flowchart illustrating an exemplary process 400 for determining a location of a vibration signal source according to some embodiments of the present disclosure. In some embodiments, the process 400 may be performed by the system 100 (e.g., the processing device 120). For example, the process 400 may be stored in a storage device (e.g., the storage device 130) in the form of programs or instructions. The process 400 may be implemented when the system 100 (e.g., the processing device 120) executes the program or instructions.

In 410, the processing device 120 may obtain a vibration transmission velocity of a solid medium. In some embodiments, the operation 410 may be performed by the location determination module 330.

The vibration transmission velocity of the solid medium may refer to a transmission velocity of a mechanical vibration in the solid medium.

In some embodiments, the processing device 120 may determine the vibration transmission velocity of the solid medium based on information input by a user through the user terminal 140.

In some embodiments, the processing device 120 may obtain relevant information of the solid medium. The processing device 120 may determine the vibration transmission velocity corresponding to the solid medium based on the relevant information of the solid medium. In some embodiments, the relevant information of the solid medium may include multiple types of information. For example, the relevant information may include size information of the solid medium (including but not limited to information such as a volume, a thickness, a length, etc.). As another example, the relevant information may include material information of the solid medium (including information such as a type of the solid medium, a vibration transmission velocity of the material of the solid medium, a shape of the solid medium, etc.). The material of the solid medium may refer to a material constituting the solid medium. In some embodiments, the processing device 120 may obtain the relevant information of the solid medium input by the user through the user terminal 140.

In some embodiments, when the relevant information of the solid medium obtained by the processing device 120 includes the vibration transmission velocity of the material of the solid medium, the processing device 120 may directly designate the vibration transmission velocity of the material of the solid medium as the vibration transmission velocity of the solid medium. For example, in the application scenario shown in FIG. 5, if relevant information of a solid medium input by a user includes a material of a touch screen, the processing device 120 may determine a vibration transmission velocity corresponding to the material from the storage device 130 (e.g., a database), and directly designate the vibration transmission velocity corresponding to the material as the vibration transmission velocity of the solid medium. In some embodiments, when the obtained relevant information of the solid medium does not include the vibration transmission velocity of the material of the solid medium, the processing device 120 may determine the vibration transmission velocity of the solid medium according to known relevant information of the solid medium. For example, if relevant information of a solid medium input by a user includes information such as a size of the solid medium, a type of the material, a shape of the solid medium, etc., the processing device 120 may select, from the storage device 130 (e.g., a database), a material of the solid medium or a vibration transmission velocity of the material of the solid medium matching the above relevant information. For example, the processing device 120 may determine that a solid medium is a ground of a basketball court based on information such as a size, a shape, etc., of the solid medium input by a user, obtain existing material information (e.g., a type of the material, a vibration transmission velocity of the material, etc.) of the ground of the basketball court from the storage device 130, and determine the vibration transmission velocity of the solid medium based on the material information.

In some embodiments, the processing device 120 may obtain the vibration transmission velocity of the solid medium by determining the vibration transmission velocity based on a distance and a time that a vibration signal transfers in the solid medium.

In some embodiments, the processing device 120 may obtain a test distance between a test vibration signal source and a test vibration sensing device and a test time when the test vibration sensing device receives the test vibration signal. The processing device 120 may further determine the vibration transmission velocity of the solid medium based on the test time and the test distance.

The test vibration signal source may refer to a vibration signal source disposed at a known location of the solid medium. The test vibration sensing device may refer to a vibration sensing device disposed at another known location of the solid medium. The test vibration sensing device may receive the test vibration signal generated by a vibration of the test vibration signal source and generate a corresponding test sensing signal. In some embodiments, the test distance between the test vibration signal source and the test vibration sensing device may be determined directly by measurement.

In some embodiments, the processing device 120 may determine the test time when the test vibration sensing device receives the test vibration signal based on the test sensing signal generated by the test vibration sensing device. For example, the processing device 120 may identify signal features in the test sensing signal, identify a target signal feature corresponding to the test vibration signal source in the signal features, and finally determine a time from the vibration signal generated by the test signal vibration source to an occurrence of the target signal feature as the test time. In some embodiments, after the test time and the test distance are obtained, the processing device 120 may obtain the vibration transmission velocity of the solid medium by dividing the test distance by the test time.

In 420, the processing device 120 may determine a location of the vibration signal source based on the vibration transmission velocity of the solid medium and a second time difference between the target signal features. In some embodiments, the operation 420 may be performed by the location determination module 330.

In some embodiments, the processing device 120 may determine the location of the vibration signal source based on the vibration transmission velocity of the solid medium and the second time difference between the target signal features. For example, in a one-dimensional scenario (e.g., a railroad track 800 shown in FIG. 8), the processing device 120 may determine a distance difference between two vibration sensing devices 110 and a same vibration signal source based on a vibration transmission velocity of a solid medium and a second time difference between target signal features, and then determine the location of the vibration signal source based on the distance difference. As another example, in a two-dimensional scenario (e.g., a contact control region 540 shown in FIG. 5), the processing device 120 may determine a location of a vibration signal source based on second time differences among target signal features received by at least three vibration sensing devices 110. For instance, taking FIG. 5 as an example, the processing device 120 may obtain a time difference between time points when a first vibration sensing device 510 and a second vibration sensing device 520 receive their respective target signal feature(s), a time difference between time points when the first vibration sensing device 510 and a third vibration sensing device 530 receive the their respective target signal feature(s), and a time difference between the time points when the second vibration sensing device 520 and the third vibration sensing device 530 receive the their respective target signal feature(s). The location of the vibration signal source may be further determined based on the three time differences.

In some embodiments, the processing device 120 may apply the process 400 to various scenarios to determine the location of the vibration signal source.

FIG. 5 is a schematic diagram illustrating an exemplary contact control device disposed with vibration sensing devices according to some embodiments of the present disclosure. As shown in FIG. 5, a contact control device 500 may include a contact control region 540. The contact control region 540 may refer to a region for receiving an instruction to control the contact control device 500. In some embodiments, the contact control region 540 may be referred to as a vibration receiving region. At least three vibration sensing devices (e.g., the first vibration sensing device 510, the second vibration sensing device 520, and the third vibration sensing device 530) may be disposed on the contact control device 500 for receiving a vibration signal generated in the contact control region 540. In some embodiments, a user may control the contact control device 500 by performing a specific operation (e.g., clicking, swiping, knocking, etc.) on the contact control region 540. In some embodiments, one or more of the at least three vibration sensing devices may be controlled by the system 100. For example, the processing device 120 of the system 100 may control one or more vibration sensing devices to operate (e.g., collect a vibration signal). As another example, the processing device 120 of the system 100 may obtain sensing signals from one or more vibration sensing devices.

In some embodiments, when a vibration signal source in a two-dimensional scenario needs to be located, at least three vibration sensing devices may need to be disposed at different locations. For example, in the embodiments shown in FIG. 5, the first vibration sensing device 510, the second vibration sensing device 520, and the third vibration sensing device 530 may be disposed at three different locations of the contact control device 500.

In some embodiments, the contact control device 500 may include a touch pad, a smart mobile phone, a mobile computer, a dance mat, etc. As shown in FIG. 5, in some exemplary application scenarios, the contact control device 500 may be a touch tablet computer. The contact control region 540 may be a region where a touch screen of the touch tablet computer is located. The user may control the touch tablet computer by performing a specific operation on the touch screen. In some embodiments, the at least three vibration sensing devices may be disposed at any locations of the touch tablet computer. For example, the first vibration sensing device 510, the second vibration sensing device 520, and the third vibration sensing device 530 may be disposed inside the touch tablet computer and directly connected with the touch screen, thereby receiving a vibration generated by the touch screen. In the embodiment, the touch screen may be a solid medium that transmits the vibration signal.

In some embodiments, the user may directly contact the touch screen through any part (e.g., a finger, an elbow, a back, etc., of a hand, a foot) of the user's body, or through other devices (e.g., a stylus pen, a hand-worn glove, etc.). For the convenience of illustration, the present disclosure may take a contact between the finger of the user and the contact control region as an example. In some embodiments, when the user uses the finger to perform the specific operation on the touch screen, a vibration signal may be generated, and each of the vibration sensing devices (e.g., the first vibration sensing device 510, the second vibration sensing device 520, and the third vibration sensing device 530) may receive the vibration signal and generate a corresponding sensing signal. In some embodiments, the system 100 may identify signal features of the sensing signals, and determine whether each of the signal features satisfies a first preset feature condition. When a signal feature satisfies the first preset feature condition, the system 100 may determine the signal feature satisfying the first preset feature condition as a target signal feature. In this embodiment, the target signal feature may refer to a signal feature corresponding to a vibration signal generated by the contact between the finger and the touch screen. In some embodiments, the target signal feature may be obtained by testing. For example, a test vibration sensing device may be disposed on the touch tablet computer. A finger may be used to perform a specific operation on the touch screen, and a signal feature corresponding to the sensing signal generated by the test vibration sensing device may be designated as the target signal feature. In some embodiments, when the system 100 identifies that the target signal features appear in the sensing signals generated by the three vibration sensing devices, the location of the finger may be determined based on time differences among occurrence times of the target signal features. For example, the system 100 may separately determine a time difference between occurrence times of the target signal features in the sensing signals generated by every two vibration sensing devices in the three vibration sensing devices, thereby determining the location of the finger.

In some embodiments, the system 100 may further determine a type of the specific operation of the user based on the signal features of the sensing signals generated by the at least three vibration sensing devices. For example, the system 100 may analyze the signal features of the sensing signals based on parameters such as a count of vibration peaks, a time interval between adjacent vibration peaks, frequency components, a signal duration, etc., to determine that the operation performed by the user is an operation such as clicking, swiping, continuously pressing, etc.

More descriptions regarding the determination of the location of the vibration signal source based on the sensing signals of the vibration sensing devices at different locations by the system 100 may be found elsewhere in the present disclosure (e.g., FIGS. 2 and 4, and the descriptions thereof), which may not be described herein.

FIG. 6 is a schematic diagram illustrating an exemplary racket disposed with vibration sensing devices according to some embodiments of the present disclosure. As shown in FIG. 6, a racket 600 may include a recommendation hitting region 640 (i.e., a region within a dashed region in FIG. 6). The recommendation hitting region may refer to a region suitable for hitting a ball. At least three vibration sensing devices (e.g., a fourth vibration sensing device 610, a fifth vibration sensing device 620, and a sixth vibration sensing device 630) may be disposed on the racket 600. For example, the at least three vibration sensing devices may be disposed on a racket net of the racket 600. Each of the at least three vibration sensing devices may be used to receive a vibration signal generated by a contact between the ball and the racket 600. In some embodiments, one or more of the at least three vibration sensing devices may be controlled by the system 100. More descriptions regarding the control may be found elsewhere in the present disclosure (e.g., FIG. 5 and the descriptions thereof), which may not be described herein.

In some embodiments, when a player hits the ball, a vibration signal may be generated when the ball is in contact with the racket 600 (including a frame, a handle, the racket net, etc.). Each of the at least three vibration sensing devices (e.g., the fourth vibration sensing device 610, the fifth vibration sensing device 620, and the sixth vibration sensing device 630) may receive the vibration signal and generate a corresponding sensing signal. In some embodiments, the system 100 may identify signal features of the sensing signals and determine whether a hitting location is within the racket net based on the signal features. In some embodiments, the system 100 may determine whether the vibration signal source is the ball based on the signal features of the sensing signals. For example, the system 100 may designate a vibration signal generated by a contact between the ball and the racket net of the racket 600 as a target signal feature. The system 100 may determine whether each of the signal features of the sensing signals generated by the at least three vibration sensing devices satisfies a second preset feature condition. When a signal feature satisfies the second preset feature condition, the system 100 may determine that the signal feature is the target signal feature. Since the vibration signal source corresponding to the signal feature is the ball, the system 100 may determine that the hitting location is located on the racket net.

In some embodiments, the system 100 may determine whether the hitting location is within the recommendation hitting region 640 based on the time differences among occurrence times of the target signal features of the sensing signals generated by the at least three vibration sensing devices (e.g., the fourth vibration sensing device 610, the fifth vibration sensing device 620, and the sixth vibration sensing device 630). In some embodiments, operations for the system 100 to determine whether the hitting location is within the recommendation hitting region 640 may be the same as or similar to the operations described in FIG. 2 and FIG. 4, which may not be described herein. In some embodiments, when the system 100 determines that the hitting location is not within the recommendation hitting region 640, the user terminal 140 may be controlled to perform a corresponding operation. Exemplary operations may include prompting that the hitting location is improper, recording the hitting location, etc. For example, the system 100 may prompt that “the hitting location is improper” through the user terminal 140 in the form of a voice, text, etc., based on a determination result that the hitting location of the ball and the racket 600 is not within the recommendation hitting region 640.

FIG. 7 is a schematic diagram illustrating a court disposed with vibration sensing devices according to some embodiments of the present disclosure. As shown in FIG. 7, a court 700 may include at least three vibration sensing devices (e.g., a seventh vibration sensing device 710, an eighth vibration sensing device 720, and a ninth vibration sensing device 730). Each of the at least three vibration sensing devices may be used to receive a vibration signal generated by a contact between a player (e.g., a foot of the player) and a court ground and a contact between a ball and the court ground, and generate a corresponding sensing signal. In some embodiments, one or more of the at least three vibration sensing devices may be controlled by system 100. More descriptions regarding the control may be found elsewhere in the present disclosure (e.g., FIG. 5 and the descriptions thereof), which may not be described herein.

In some embodiments, a type of the court 700 may include a soccer field, a basketball court, a badminton court, etc. As shown in FIG. 7, in some exemplary application scenarios, the court 700 may be the basketball court. The court 700 may include a court ground and corresponding equipment (e.g., a net, basketball hoops, etc.) disposed on the court ground. The seventh vibration sensing device 710 may be disposed on an upper half region of the court 700, and the eighth vibration sensing device 720 and the ninth vibration sensing device 730 may be disposed on a lower half region of the court 700, respectively.

In some embodiments, after obtaining the sensing signals generated by the at least three vibration sensing devices (e.g., the seventh vibration sensing device 710, the eighth vibration sensing device 720, and the ninth vibration sensing device 730), the system 100 may identify signal features of the sensing signals, and determine target signal features corresponding to the vibration signal source. In this embodiment, the vibration signal source may include the player (e.g., the foot of the player) and the ball. The signal feature corresponding to the player may be referred to as a first target signal feature. The signal feature corresponding to the ball may be referred to as a second target signal feature. In some embodiments, the first target signal feature and the second target signal feature may be obtained by testing. For example, the ball may be thrown to the court ground, and a vibration signal generated by a contact between the ball and the court ground may be obtained by using one or more vibration sensing devices. The system 100 may identify a signal feature of the sensing signals generated by the one or more vibration sensing devices, and designate the signal feature as the second target signal feature. In some embodiments, the system 100 may store the obtained first target signal feature and the obtained second target signal feature in the storage device 130.

In some embodiments, the system 100 may determine whether each of the signal features of the sensing signals satisfies a third preset feature condition or a fourth preset feature condition. When a signal feature satisfies the third preset feature condition, the system 100 may determine the signal feature satisfying the third preset feature condition as the first target signal feature, and the corresponding vibration signal source may be the player. When a signal feature satisfies the fourth preset feature condition, the system 100 may determine the signal feature satisfying the fourth preset feature condition as the second target signal feature, and the corresponding vibration signal source may be the ball. In some embodiments, when the system 100 determines that the sensing signals generated by each of the at least three vibration sensing devices include the same target signal feature, a location of the vibration signal source corresponding to the target signal features may be determined based on time differences among occurrence times of the target signal features. For example, when the system 100 determines that sensing signals generated by each of the seventh vibration sensing device 710, the eighth vibration sensing device 720, and the ninth vibration sensing device 730 include the first target signal feature, the system 100 may determine time differences based on an occurrence time of the first target signal feature in the sensing signals of each of the three vibration sensing device, thereby determining the location of the player on the court ground.

In some embodiments, the system 100 may further determine a type of a specific operation that the player performs on the court. The specific operation may include jumping, squatting, sprinting, falling, etc. In some embodiments, after the system 100 identifies that the sensing signals include a signal feature corresponding to the first target signal feature, the specific operation of the player may be further determined based on the first target signal feature. In this embodiment, when the player performs operations such as jumping, squatting, etc., generated vibration signals may be different, so that the signal features of the corresponding sensing signals may be also different. Therefore, the system 100 may determine the specific type of operation performed by the player based on differences in the signal features. In some embodiments, the system 100 may determine a motion trajectory of the player based on locations of the player at a plurality of time points. In some embodiments, the system 100 may determine the specific operation of the player based on the motion trajectory of the player. For example, the system 100 may determine a motion velocity of a player based on a motion trajectory of the player. When the motion velocity of the player is greater than a velocity threshold, the system 100 may determine that the player is sprinting.

In some embodiments, the method for locating the vibration signal source provided in the present disclosure may also be used to determine a location of a defective pixel of an object to be detected. In some embodiments, vibration signals generated by a vibration of the object to be detected may be received by connecting the vibration sensing devices 110 to the object to be detected, thereby determining the location of the defective pixel according to sensing signals corresponding to the vibration signals. In this embodiment, a vibration signal may be generated when the object to be detected performs a specific vibration behavior (the defective pixel of the object to be detected performs the specific vibration behavior at the same time). Since a signal feature of a sensing signal corresponding to a vibration signal generated by the defective pixel of the object to be detected is different from a signal feature of a sensing signal corresponding to a vibration signal generated by a normal portion of the object to be detected, the location of the defective pixel may be determined by analyzing the signal features of the sensing signals corresponding to the vibration signal received by the vibration sensing devices. The object to be detected may refer to a subject that needs to be detected to determine the location of the defective pixel. For example, in the embodiments shown in FIG. 8, the object to be detected may be a railroad track 800. The defective pixel may refer to a faulty portion on the object to be detected. For example, in the embodiments shown in FIG. 8, a defective pixel 830 may be a location on the railroad track 800 where a fracture occurs. In some embodiments, a signal feature corresponding to the defective pixel may also be referred to as an abnormal signal feature. The abnormal signal feature may refer to relevant information that can reflect a vibration signal feature generated by the vibration of the defective pixel. In some embodiments, target signal features may include abnormal signal features corresponding to the defective pixel. In some embodiments, the signal features of the vibration signals received by the vibration sensing devices connected to the object to be detected may include abnormal signal feature and other types of signal features. For example, a signal feature of a vibration signal generated by a vibration of a portion of the object to be detected except the defective pixel may be referred to as a normal signal feature.

In some embodiments, a difference between the abnormal signal feature and the normal signal feature may include differences relating to a count of vibration peaks, a time interval between adjacent vibration peaks, frequency components, a signal duration, or the like, or any combination thereof. In some embodiments, the system 100 may determine whether a signal feature satisfies a fifth preset feature condition. When the signal feature satisfies the fifth preset feature condition, the system 100 may determine the signal feature as the abnormal signal feature, and further determine the vibration signal source as the defective pixel. For example, the system 100 may compare all signal features with the normal signal feature. If a signal feature is different from the normal signal feature, the signal feature may be determined as a target signal feature (i.e., the abnormal signal feature corresponding to the defective pixel).

For the convenience of illustration, the present disclosure may further describe how to determine the location of the defective pixel of the object to be detected by taking the railroad track as an example.

FIG. 8 is a schematic diagram illustrating an exemplary railroad track disposed with vibration sensing devices according to some embodiments of the present disclosure. As shown in FIG. 8, the railroad track 800 has at least one defective pixel, for example, a defective pixel 830. In some embodiments, the railroad track 800 may be regarded as a line segment extending along a length direction of the railroad track 800, and the defective pixel 830 may be regarded as a point on the line segment. In some embodiments, at least two vibration sensing devices (e.g., a tenth vibration sensing device 810 and an eleventh vibration sensing device 820) may be disposed at different locations on the railroad track 800. In some embodiments, one or more of the at least two vibration sensing devices may be controlled by the system 100. More descriptions regarding the control may be found elsewhere in the present disclosure (e.g., FIG. 5 and the descriptions thereof), which may not be described herein.

It should be noted that, since the railroad track 800 can be regarded as the line segment extending along the length direction of the railroad track 800, determining the location of the defective pixel 830 on the railroad track 800 may be equivalent to determining a location of a point in a one-dimensional scenario. Therefore, in the one-dimensional scenario, two vibration sensing devices may be used to determine the location of the vibration signal source. For example, two circles may be obtained by taking each of two vibration sensing devices as a center of a circle and a distance between each of the two vibration sensing devices and the vibration signal source as a radius. An intersection point of the line segment and the two circles may be the location of the vibration signal source.

In some embodiments, the system 100 may receive vibration signals generated by a vibration of the railroad track 800 through the at least two vibration sensing devices (e.g., the tenth vibration sensing device 810 and the eleventh vibration sensing device 820) disposed at different locations of the railroad track 800. Since the defective pixel 830 on the railroad track 800 vibrates with the vibration of the railroad track 800, the defective pixel of the railroad track may also generate a corresponding vibration signal. The system 100 may identify signal features in sensing signals generated after the at least two vibration sensing devices receive the vibration signals, and identify target signal features corresponding to the defective pixel 830 in the signal features. Finally, the system 100 may determine the location of the defective pixel 830 based on a second time difference between the target signal features in the sensing signals generated by the tenth vibration sensing device 810 and the eleventh vibration sensing device 820.

In some embodiments, the location of the defective pixel 830 may be roughly estimated before the at least two vibration sensing devices are disposed. For example, the staff may determine that the defective pixel 830 is roughly located on a portion of the railroad track 800 shown in FIG. 8. Then the staff may dispose the tenth vibration sensing device 810 and the eleventh vibration sensing device 820 at both ends of the railroad track 800, respectively. After the tenth vibration sensing device 810 and the eleventh vibration sensing device 820 are disposed, an exact location of the defective pixel 830 may be determined by the tenth vibration sensing device 810 and the eleventh vibration sensing device 820. In some cases, roughly estimating the location of the defective pixel 830 before disposing the at least two vibration sensing devices may reduce a count of vibration sensing devices to be required, thereby reducing a detection cost.

In some other embodiments, a plurality of vibration sensing devices may be disposed on the railroad track 800 at equal intervals along the length direction of the railroad track 800. In this embodiment, the exact location of the defective pixel may be determined by receiving the vibration signal generated by the vibration of the railroad track 800.

In some embodiments, the system 100 may determine whether each of the signal features of the sensing signals satisfies a sixth preset feature condition, thereby determining whether an abnormal signal feature appears in the sensing signals. For example, the system 100 may determine whether each of the signal features satisfies the sixth preset feature condition based on the count of vibration peaks, the time interval between adjacent vibration peaks, the frequency components, the signal duration, etc., of each sensing signal. If a signal feature satisfies the sixth preset feature condition (e.g., the frequency components are different or a similarity degree of the frequency components does not reach a similarity threshold), the system 100 may determine the signal feature as an abnormal signal feature.

In some embodiments, the system 100 may also determine the abnormal signal feature based on an abnormal signal feature determination model. The system 100 may input each of the signal features of the sensing signals generated by the at least two vibration sensing devices receiving the vibration signals into the abnormal signal feature determination model. An output of the abnormal signal feature determination model may include whether the signal features include an abnormal signal feature. In some embodiments, the abnormal signal feature determination model may be a third machine learning model. More descriptions regarding the obtaining and training of the abnormal signal feature determination model may be found elsewhere in the present disclosure, which may not be described herein.

In some embodiments, the system 100 may determine the location of the defective pixel 830 based on a time difference (also referred to as a third time difference) between occurrence times of the abnormal signal features of the sensing signals generated by the at least two vibration sensing devices disposed at different locations on the railroad track 800. In this embodiment, the defective pixel may be regarded as the vibration signal source. More descriptions regarding the determination of the location of the vibration signal source based on the time difference may be found elsewhere in the present disclosure (e.g., FIGS. 2 and 4, and the descriptions thereof), which may not be described herein.

In some embodiments, the system 100 may also be applied in other application scenarios, for example, the field of smart home, smart wear, etc.

In some embodiments, the vibration sensing device 110 may be integrated into or disposed on (e.g., by bonding, buckle connection, etc.) a wearable device. When a user wears the wearable device, the vibration sensing device may completely and accurately receive a vibration signal generated by a body activity of the user and transmitted through bones or muscles of the user. In some embodiments, the wearable device may include a pair of glasses, a headphone, etc.

Merely by way of example, the wearable device may include a headphone (e.g., an in-ear headphone). One or more components or units of the system 100 may be integrated on the headphone or communicatively connected to the headphone. For example, the headphone may be disposed with the vibration sensing device 110 for collecting a vibration signal generated by a body activity of a user. In this embodiment, the body activity of the user may include knocking on teeth of the user, rubbing the teeth of the user, chewing and swallowing, etc. The user may generate the vibration signal by knocking on the teeth of the user, rubbing the teeth of the user, chewing and swallowing, etc. The vibration signal may be transmitted to the vibration sensing device 110 via bones or facial muscles of the user.

In some embodiments, when the user chews and swallows the food, the system 100 may determine a type of the food based on signal features of sensing signals generated by a plurality of vibration sensing devices 110. In some embodiments, the system 100 may determine whether each of the signal features satisfies a seventh preset feature condition corresponding to a food type. When the seventh preset feature condition is satisfied, the food type corresponding to the signal feature may be determined.

In some embodiments, the system 100 may determine a location of the knocking or rubbing of the teeth based on the signal features of the sensing signals generated by the vibration sensing device 110. In this embodiment, the knocking or rubbing of the teeth may occur between the teeth of the upper gum and the teeth of the lower gum. The vibration signal source corresponding to the knocking or rubbing of the teeth may be obtained through the embodiments in the present disclosure. In some embodiments, the headphone may include a left ear portion and a right ear portion. Each of the left ear portion and the right ear portion may be disposed with one vibration sensing device 110. The system 100 may identify a second time difference between target signal features in sensing signals generated by the two vibration sensing devices 110 to determine the location of the knocking or rubbing of the teeth. The target signal features may correspond to a vibration signal generated by the knocking or rubbing of the teeth.

In some embodiments, the system 100 may also be applied in smart home scenarios. For example, the smart home may include a smart light. The user may control the smart light by performing a specific operation on a surface of the smart light. The smart light may be communicated with and/or connected to one or more other components of the system 100. At least three vibration sensing devices 110 may be disposed on the smart light to detect a vibration signal generated when the user contacts with the smart light. In some embodiments, the system 100 may determine a location where the user (e.g., a finger of the user) is in contact with the smart light based on target signal features of sensing signals generated by the at least three vibration sensing devices 110. The target signal feature may correspond to the vibration signal generated by the contact between the finger of the user and the surface of the smart light.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, specific terminology has been used to describe embodiments of the present disclosure. For example, the terms “one embodiment,” “an embodiment,” and/or “some embodiments” mean that a particular feature, structure, or feature described in connection with the embodiment is included in at least one embodiment of the present disclosure. Therefore, it is emphasized and should be appreciated that two or more references to “an embodiment,” or “one embodiment,” or “an alternative embodiment” in various portions of this specification are not necessarily all referring to the same embodiment. Furthermore, the particular features, structures, or features may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or collocation of matter, or any new and useful improvement thereof. Accordingly, aspects of the present disclosure may be implemented entirely hardware, entirely software (including firmware, resident software, micro-code, etc.), or combining software and hardware implementation that may all generally be referred to herein as a “unit,” “module,” or “system.” Furthermore, aspects of the present disclosure may take the form of a computer program product embodied in one or more computer readable media having computer-readable program code embodied thereon.

Furthermore, the recited order of processing elements or sequences, or the use of numbers, letters, or other designations, therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution—e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

In some embodiments, numbers describing the number of ingredients and attributes are used. It should be understood that such numbers used for the description of the embodiments use the modifier “about,” “approximately,” or “substantially” in some examples. Unless otherwise stated, “about,” “approximately,” or “substantially” indicates that the number is allowed to vary by ±20%. Correspondingly, in some embodiments, the numerical parameters used in the description and claims are approximate values, and the approximate values may be changed according to the required features of individual embodiments. In some embodiments, the numerical parameters should consider the prescribed effective digits and adopt the method of general digit retention. Although the numerical ranges and parameters used to confirm the breadth of the range in some embodiments of the present disclosure are approximate values, in specific embodiments, settings of such numerical values are as accurate as possible within a feasible range.

Finally, it should be understood that the embodiments described in the present disclosure are only used to illustrate the principles of the embodiments of the present disclosure. Other variations may also fall within the scope of the present disclosure. Therefore, as an example and not a limitation, alternative configurations of the embodiments of the present disclosure may be regarded as consistent with the teaching of the present disclosure. Accordingly, the embodiments of the present disclosure are not limited to the embodiments introduced and described in the present disclosure explicitly.

1. A method for locating a vibration signal source, comprising:
obtaining sensing signals of at least two vibration sensing devices located at different locations, each of the sensing signals being generated by one of the at least two vibration sensing devices by sensing a vibration signal, which is generated by a vibration from the same vibration signal source;
determining, based on the sensing signals, a first time difference between time points when the at least two vibration sensing devices located at different locations receive the vibration signal; and
determining, based on the first time difference, a location of the vibration signal source, wherein the first time difference is determined based on a second time difference between occurrence times of target signal features corresponding to the vibration signal source in signal features of the sensing signals.

2. The method of claim 1, wherein the method further includes:
identifying the signal features of the sensing signals;
identifying the target signal features corresponding to the vibration signal source in the signal features; and
determining the second time difference between the occurrence times of the target signal features.

3. The method of claim 2, wherein the identifying the signal features of the sensing signals includes:
determining, based on spectra of the sensing signals, the signal features of the sensing signals.

4. The method of claim 2, wherein the identifying the target signal features corresponding to the vibration signal source in the signal features includes:
identifying the target signal features in the sensing signals using a target signal feature identification model, wherein the target signal feature identification model is a machine learning model.

5. The method of claim 1, further comprising:
obtaining locations of the vibration signal source at a plurality of time points; and
determining, based on the locations of the vibration signal source at the plurality of time points, a motion trajectory of the vibration signal source.

6. The method of claim 5, further comprising:
determining, based on the motion trajectory of the vibration signal source, a next location of the vibration signal source.

7. The method of claim 6, wherein the determining, based on the motion trajectory of the vibration signal source, a next location of the vibration signal source includes:
determining, based on the motion trajectory of the vibration signal, a motion velocity and a motion acceleration of the vibration signal source at a current location; and
determining, based on the motion velocity and the motion acceleration of the vibration signal source at the current location and the current location of the vibration signal source, the next location of the vibration signal source.

8. The method of claim 2, wherein the at least two vibration sensing devices located at different locations are respectively connected to a vibration receiving region through a solid medium, and generate the sensing signals in response to the vibration generated by the same vibration signal source in the vibration receiving region.

9. The method of claim 8, wherein the at least two vibration sensing devices located at different locations are respectively fixedly connected to the solid medium through at least one of a bonding connection, an inlaying connection, a welding connection, a riveting connection, or a screw connection; or
the at least two vibration sensing devices located at different locations are detachably connected to the solid medium.

10. (canceled)

11. The method of claim 9, wherein the determining, based on the first time difference, a location of the vibration signal source includes:
obtaining a vibration transmission velocity of the solid medium; and
determining the location of the vibration signal source based on the vibration transmission velocity of the solid medium and the second time difference between occurrence times of the target signal features.

12. The method of claim 11, wherein the obtaining a vibration transmission velocity of the solid medium includes:
obtaining relevant information of the solid medium; and
determining, based on the relevant information of the solid medium, the vibration transmission velocity corresponding to the solid medium.

13. (canceled)

14. The method of claim 11, wherein the obtaining a vibration transmission velocity of the solid medium includes:
obtaining a test distance between a test vibration signal source and a test vibration sensing device;
obtaining a test time when the test vibration sensing device receives the test vibration signal; and
determining, based on the test time and the test distance, the vibration transmission velocity of the solid medium.

15. The method of claim 9, wherein at least three vibration sensing devices of the at least two vibration sensing devices are respectively disposed at different locations of a contact control device, wherein the contact control device includes a contact control region, and the at least three vibration sensing devices generate the sensing signals in response to the vibration of the same vibration signal source in the contact control region.

16. The method of claim 9, wherein at least three vibration sensing devices of the at least two vibration sensing devices are disposed at different locations of a racket, and the method further includes:
determining whether the location of the vibration signal source is within a recommendation hitting region; and
in response to a determination result that the location of the vibration signal source is not within the recommendation hitting region, prompting that a hitting location is improper.

17. The method of claim 9, wherein the at least two vibration sensing devices are disposed at different locations of an object to be detected, and the target signal features include abnormal signal features corresponding to a defective pixel of the object to be detected.

18. The method of claim 17, wherein the object to be detected includes a railroad track.

19. The method of claim 18, wherein the identifying the target signal features corresponding to the vibration signal source in the signal features further includes:
for each of the signal features of the sensing signals,
determining whether the signal feature satisfies a preset feature condition; and
in response to a determination result that the signal feature satisfies the preset feature condition, determining the signal feature as one of the abnormal signal features.

20. The method of claim 19, wherein the determining, based on the first time difference, a location of the vibration signal source further includes:
determining a location of the defective pixel based on a third time difference between occurrence times of the abnormal signal features.

21. A system for locating a vibration signal source, comprising:
at least one storage device configured to store computer instructions; and
at least one processor in communication with the at least one storage device, wherein when executing the computer instructions, the at least one processor is configured to direct the system to perform operations including:
obtaining sensing signals of at least two vibration sensing devices located at different locations, each of the sensing signals being generated by one of the at least two vibration sensing devices by sensing a vibration signal, which is generated by a vibration from the same vibration signal source;
determining, based on the sensing signals, a first time difference between time points when the at least two vibration sensing devices located at different locations receive the vibration signal; and
determining, based on the first time difference, a location of the vibration signal source, wherein the first time difference is determined based on a second time difference between occurrence times of target signal features corresponding to the vibration signal source in signal features of the sensing signals.

22-40. (canceled)

41. A non-transitory computer readable medium, comprising:
at least one set of computer instructions;
wherein when executed by at least one processor, the at least one set of computer instructions direct the at least one processor to perform operations including:
obtaining sensing signals of at least two vibration sensing devices located at different locations, each of the sensing signals being generated by one of the at least two vibration sensing devices by sensing a vibration signal, which is generated by a vibration from the same vibration signal source;
determining, based on the sensing signals, a first time difference between time points when the at least two vibration sensing devices located at different locations receive the vibration signal; and
determining, based on the first time difference, a location of the vibration signal source, wherein the first time difference is determined based on a second time difference between occurrence times of target signal features corresponding to the vibration signal source in signal features of the sensing signals.
